(19) United States
(12) Patent Application Publication
(10) Pub. No.: US 2008/0212744 A1
(43) Pub. Date: Sep. 4, 2008

(54) Method, system, apparatus, and program for verifying media service features

(75) Inventors: Michael J. Wurst, Santa Rosa, CA (US); Forrest J. Chesser, Lewisville, TX (US); Marc R. Bernard, Miramar, FL (US); Douglas A. Atkinson, Ashburn, VA (US); John T. Burch, McLean, VA (US)

Correspondence Address: FITZPATRICK CELLA HARPER & SCINTO, 30 ROCKEFELLER PLAZA, NEW YORK, NY, 10112, US

(73) Assignee: TELLABS OPERATIONS, INC., Naperville, IL (US)

(21) Appl. No.: 11/953,852

(22) Filed: Dec. 10, 2007

Related U.S. Application Data
(60) Provisional application No. 60/873,930, filed on Dec. 9, 2006.

(51) Int. Cl. H04M 1/24

(52) U.S. Cl. 379/27.01

(57) ABSTRACT

Methods, systems, and computer program products are provided for verifying a service provided to at least one subscriber terminal in a communication network. The method includes connecting a communication device to the network, logging into a test unit communicatively coupled to the network using the communication device, entering into the communication device an access code corresponding to a test for verifying a service, and conducting the test for verifying the service, corresponding to the access code.

### CROSS REFERENCE TO RELATED APPLICATIONS

This application claims the benefit of U.S. provisional application No. 60/873,930, filed Dec. 9, 2006, which is hereby incorporated by reference herein in its entirety, as if fully set forth herein. Further, this application is related to application Ser. No. 11/367,423, filed on Mar. 6, 2006, entitled “Craft Menu System Using Caller ID Functionality for Installation and Testing”, which is a continuation of application Ser. No. 10/662,716, entitled “Craft Menu System Using Caller ID Functionality for Installation and Testing”, now U.S. Pat. No. 7,123,692 B2. Application Ser. No. 11/367,423 and U.S. Pat. No. 7,123,692 B2 are each also hereby incorporated by reference herein in their entireties, as if fully set forth herein.

### BACKGROUND OF THE INVENTION

1. Field of the Invention

Example aspects of the invention relate in general to communications systems and more particularly to improved methods, systems, apparatuses, and programs for verifying media (e.g., voice, data, and/or video) features and services throughout a communications network.

2. Related Art

There is a growing demand in the communications industry to find a solution to transmit voice, data, or video from a headend to a subscriber's premises, through a fiber optic network and all the way into an individual home or business. Such fiber optic networks generally are referred to as fiber-to-the-home (FTTH), fiber-to-the-premises (FTTP), fiber-to-the-business (FTTB), fiber-to-the-node (FTTN), or fiber-to-the-curb (FTTC) networks and the like, depending on the specific application of interest. Such types of networks are also referred to herein generally as “FTTx networks”.

In a typical FTTx network, equipment at a headend or central office couples the FTTx to external services such as a Public Switched Telephone Network (PSTN) or an external network. Signals received from these services are converted into optical signals and are combined onto a single optical fiber at a plurality of wavelengths, with each wavelength defining a channel within the FTTx network.

In a FTTP network, the optical signals are transmitted through the FTTP network to an optical splitter that splits the optical signals and transmits the individual optical signals over a single optical fiber to a subscriber's premises. At the subscriber's premises, the optical signals are converted into electrical signals using an Optical Network Terminal (ONT). The ONT may split the resultant signals into separate services required by the subscriber such as computer networking (data), telephony and video. In FTTC and FTTN networks, the optical signal is converted to an electrical signal by either an Optical Network Unit (ONU) (FTTC) or a Remote Terminal (RT) (FTTN), before being provided to a subscriber's premises.

A typical FTTx network often includes one or more Optical Line Terminals (OLTs) which each include one or more Passive Optical Network (PON) cards. Such a network is illustrated in FIG. 2. Each OLT typically is communicatively coupled to one or more ONTs (in the case of a FTTP network), or to one or more Optical Network Units (ONU) (in the case of a FTTC network), via an Optical Distribution Network (ODN). In a FTTP network, the ONTs are communicatively coupled to customer premises equipment (CPE) used by end users (e.g., customers or subscribers) of network services. In a FTTC network, the ONU's are communicatively coupled to network terminals (NT), and the NTs are communicatively coupled to CPE. NTs can be, for example, digital subscriber line (DSL) modems, asynchronous DSL (ADSL) modems, very high speed DSL (VDSL) modems, or the like. In a FTTN network, each OLT typically can be communicatively coupled to one or more RTs. The RTs are communicatively coupled to NTs that are communicatively coupled to CPE.

Accordingly, PONs are an emerging broadband, multi-services, access technology allowing the benefits of fiber optic transmission to be pushed closer to the customer, including directly to the customer location. A PON, being a point-to-multipoint, fiber-to-the-premises network architecture, enables two-way traffic on a single fiber optic cable. Installed first costs can be reduced by allowing an optical transceiver at the network end of the access system to be shared with many customers and minimizing the number of trunk/feeder fibers toward the customer premises. Operation costs are reduced by the passive nature of the optical distribution network. Example standards for PONs include ITU-T G.983 for an ATM Passive Optical Network (APON) or Broadband PON (BPON), ITU-T G.984 for a Gigabit PON (GPON), and IEEE 802.3ah for an Ethernet PON (EPON).

Service providers have a requirement of automated verification of operability of media features to ensure customer satisfaction, reduction in trouble reports post installation, and verification of customer premises equipment (CPE) compatibility with fiber to the premise equipment, such as the ONT. A CPE includes any customer equipment which can receive and provide communications in the passive optical network, including, for example, standard telephones (Public-Switched Telephone Network (PSTN) and cellular), Internet Protocol telephones, Ethernet units, television monitors, computer terminals, digital subscriber line connections, cable modems, wireless access, set top boxes, broadband home routers, telephony display devices, as well as any other conventional device.

### SUMMARY OF THE INVENTION

Example aspects of the invention include methods, systems, apparatuses, and programs for verifying (i.e., confirming correct operations of) media service features throughout a communications network such as, for example, a FTTx network (e.g., FTTH, FTTP, FTTB, FTTN, and FTTC). The terms “media,” “services,” and the like as used herein include, for example, at least voice (e.g., Class V), video, and data services. The term “media service features,” as used herein, refers to, for example, at least, in the case of voice services, Class V switch features, e.g., Caller ID and Call Waiting or the like, or other types of voice or data or video features. The term “class services” is used broadly herein to refer to Class V services or Class V features or the like.

According to an example aspect of the invention, a method for verifying a media service feature provided to at least one subscriber terminal in a communication network includes (1) connecting a communication device to the network, (2) logging into a test unit communicatively coupled to the network using the communication device, (3) entering into the communication device an access code corresponding to a test for verifying a service, and (4) conducting the test for verifying the service, corresponding to the access code.

Further features and advantages, as well as the structure and operation, of various example embodiments of this invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the drawings in which like reference numbers indicate identical or functionally similar elements.

FIG. 1A illustrates a diagram of a passive optical network, according to an example embodiment of the invention;

FIG. 1B illustrates a physical hardware implementation implementing a passive optical network, according to an example embodiment of the present invention;

FIG. 1C illustrates a block diagram of a system including an optical network terminal and a telephony device, according to an example embodiment of the invention;

FIG. 2 illustrates a typical FTTx network;

FIG. 3 is an architecture diagram of a data processing system or device according to an example embodiment of the invention;

FIG. 4 shows an example of a menu list of provisioned voice services on an ONT;

FIG. 5 is a logical diagram of modules in accordance with an example embodiment of the present invention;

FIG. 6 is a flow diagram that illustrates a method in accordance with an example embodiment of this invention;

FIG. 7 is a flow diagram that illustrates a method for verifying Caller ID functionality in accordance with an example embodiment of this invention;

FIG. 8, which includes FIGS. 8A and 8B, is a flow diagram that illustrates a method for verifying Call Waiting functionality in accordance with an example embodiment of this invention;

FIG. 9, which includes FIGS. 9A and 9B, is a flow diagram that illustrates a method for verifying Call Waiting Caller ID functionality in accordance with an example embodiment of this invention;

FIG. 10, which includes FIGS. 10A and 10B, is a flow diagram that illustrates a method for verifying Message Waiting Indicator functionality in accordance with an example embodiment of this invention; and

FIG. 11 is a signaling diagram that illustrates a method for testing media service features in accordance with an example embodiment of the invention.

### DETAILED DESCRIPTION OF THE PREFERRED EMBODIMENTS

Example embodiments of this invention can be used to verify media (e.g., voice, data, and/or video) services and features provided though a communications network such as, for example, a FTTx network (e.g., FTTH, FTTP, FTTB, FTTN, and FTTC). Such media services and features can include those for traditional analogue voice (Plain Old Telephone Service (POTS)) solutions, Voice over Internet Protocol (VoIP) solutions, Session Initiation Protocol (SIP) solutions, and the like. Indeed, the example aspects of the invention can be used to verify and validate call features for any solution that has, for example, a VoIP engine (for example SIP, H.248 or the like) for signaling, and analogue-to-packet SAR (segmentation and reassembly) for media (voice, video, data, or the like). Accordingly, the example aspects of the invention can be used to verify not only voice services but also media services such as a video conference feature, a VoD (Video on Demand) feature, a music streaming feature, and the like, and are not limited to verifying only those types of services or others described herein.

FTTN solutions that can be verified include for example ATA (Analog Telephone Adapter) equipment, that is, external devices plugged into CPE LAN to support media signaling and communication. ATA equipment connects a standard telephone to a computer network to enable calls to be made over the Internet. For example, Vonage requires ATA devices. The example aspects of the invention can be used to verify, among others, call features for ATA applications.

POTS is the standard telephone service that is a basic form of residential and small business telephone available service almost everywhere in the world. POTS offers services including caller ID, call waiting, voice mail, conference calling, etc. VoIP, also typically referred to as IP Telephony, Internet telephony, Broadband telephony, Broadband Phone, and Voice over Broadband, is the routing of voice conversations over the Internet or through any other IP-based network. VoIP can include services such as caller ID, and can support existing POTS voice services, signaling, and transport for other media such as, for example, video and music.

SIP is an application-layer control (signaling) protocol for creating, modifying, and terminating sessions with one or more participants. These sessions include Internet telephone calls, multimedia distribution, and multimedia conferences. SIP is a lightweight, transport independent, text based protocol, and is widely used as a signaling protocol for VoIP and others. Of course, the example aspects of the invention can apply to other packet-based signaling standards as well, such as H.248.

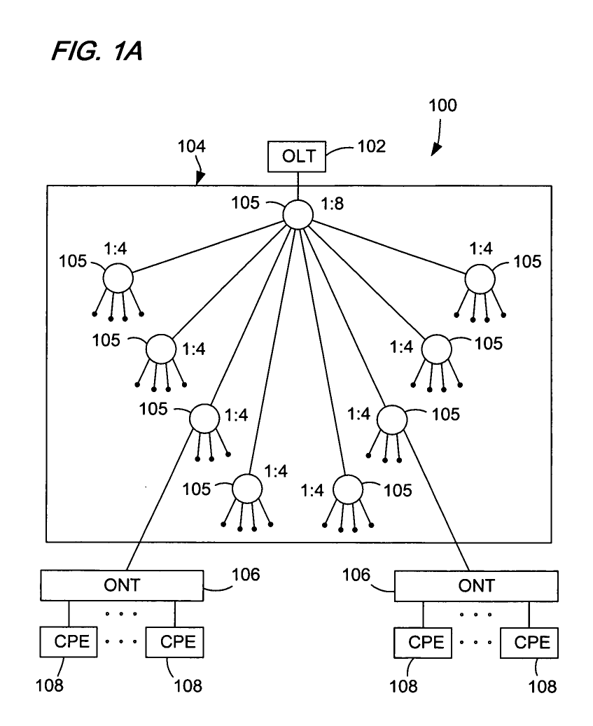

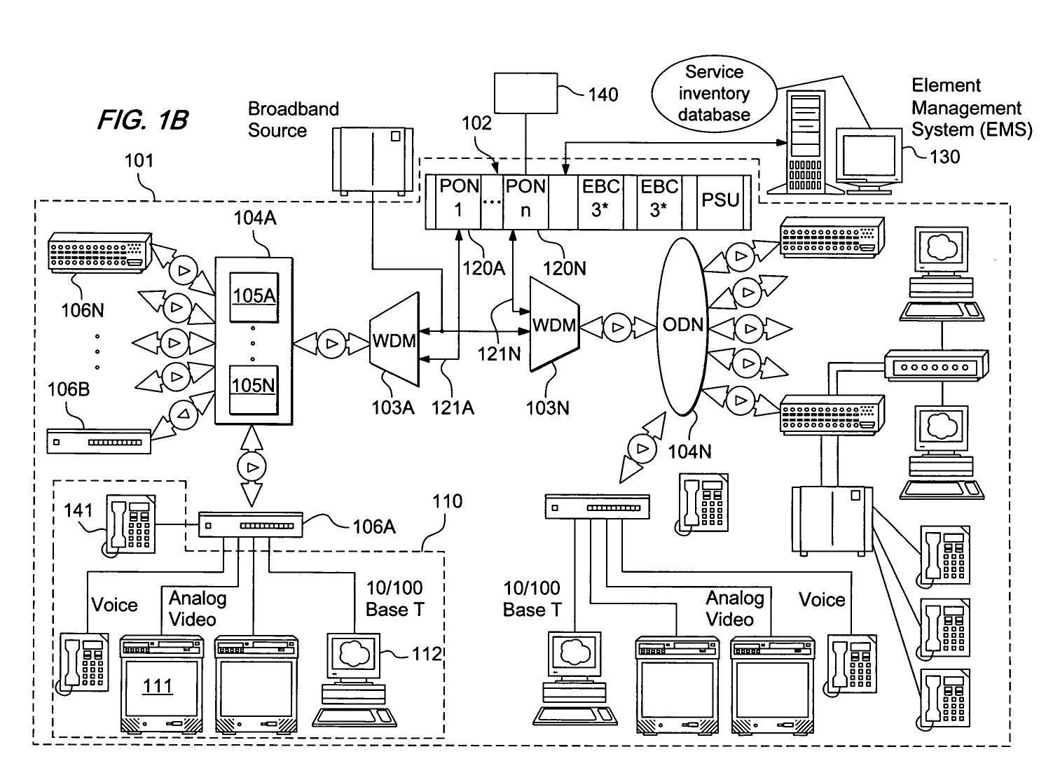

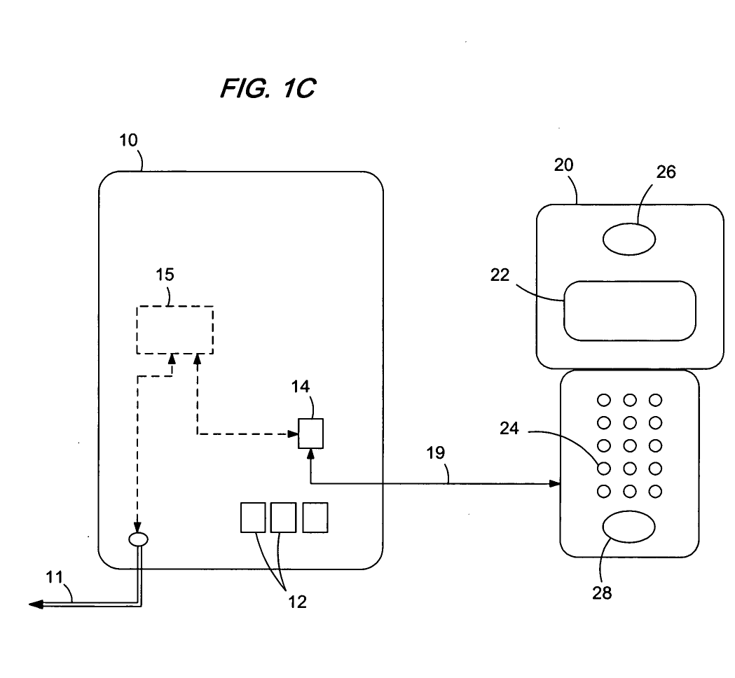

FIG. 1A shows a diagram of an example passive optical network (PON) 100 that is suitable for practicing example aspects of the invention. PON 100 includes at least one optical line terminal (OLT) 102, at least one optical distribution network device 104, one or more optical network terminals (ONTs) 106, and customer premises equipment (CPE) 108. Optical line terminal 102 provides a single optical feed that is distributed through optical distribution network device 104 by one or more layers of separate splitters 105 to optical network terminals 106 in order to provide communications to and from customer premises equipment 108.

Passive optical network 100 may be deployed for, by example, fiber-to-the-business (FTTB), fiber-to-the-curb (FTTC), fiber-to-the-home (FTTH) and for any fiber-to-the-‘X’ application. The main optical fiber in passive optical network 100 may operate at, for example, bandwidths such as 155 Mb/sec, 622 Mb/sec, 1.25 Gb/sec, and 2.5 Gb/sec or any other suitable bandwidth implementations. Passive optical network 101 may incorporate asynchronous transfer mode (ATM) communications, broadband services such as Ethernet access and video distribution, Ethernet point-to-multipoint topologies, and native communications of data and time division multiplex formats, for example.

FIG. 1B is another network diagram of an example passive optical network (PON) 101, that may form, at least in part, a more detailed representation of the network of FIG. 1. The PON 101 includes an optical line terminal (OLT) 102, wavelength division multiplexers 103a-n, optical distribution network (ODN) devices 104a-n, ODN device splitters (e.g., 105a-n associated with ODN device 104a), optical network terminals (ONTs) (e.g., 106-n corresponding to ODN device splitters 105a-n), and customer premises equipment (e.g., 110). The OLT 102 includes PON cards 120a-n, each of which provides an optical feed (121 a-n) to ODN devices 104a-n. Optical feed 121a, for example, is distributed through corresponding ODN device 104a by separate ODN device splitters 105a-n to respective ONTs 106a-n in order to provide communications to and from customer premises equipment 110.

PON 101 includes one or more different types of ONTs (e.g., 106a-n). Each ONT 106a-n, for example, communicates with an ODN device 104a through associated ODN device splitters 105a-n. Each ODN device 104a-n in turn communicates with an associated PON card 120a-n through respective wavelength division multiplexers 103a-n. Wavelength division multiplexers 103a-n are optional components which are used when video services are provided. Communications between the ODN devices 104a-n and the OLT 102 occur over a downstream wavelength and an upstream wavelength. The downstream communications from the OLT 102 to the ODN devices 104a-n may be provided at, for example, 622 megabytes per second, which is shared across all ONTs communicatively coupled to the ODN devices 104a-n. The upstream communications from the ODN devices 104a-n to the PON cards 120a-n may be provided at, for example, 155 megabytes per second, which is shared among all ONTs communicatively coupled to ODN devices 104a-n.

FIG. 1B further illustrates the OLT 102 managed by an Element Management System (EMS) 130, which may be part of the PON 101 or be external thereto. Since the OLT 102 includes the PON cards 120a-n, each PON card 120a-n is also managed by the EMS 130. As such, a single EMS manages all PON cards within a PON. A single EMS, however, may manage or otherwise be associated with more than one PON. As such, a single EMS is not limited to managing PON cards within a single PON, but may manage PON cards from several PONs, or more than one EMS can manage a single or plural PONs. The EMS 130 enables login to the OLT 102 locally. Alternatively, the EMS 130 is programmable to send a command to the OLT 102, enabling control thereof from a remote location (e.g. a mobile communication device).

For use by local operating companies and the like to verify features and services within a passive optical network, an example embodiment of the invention includes an intelligent test unit which can originate and terminate, e.g., voice calls, or other types of service communication. The test unit (such as test unit 140 shown in FIG. 1B) can be part of the PON 101 or be external thereto. According to an example embodiment of the invention, test unit 140 is separate from, but communicatively coupled to, an OLT (such as OLT 102 shown in FIG. 1B). In another example embodiment of the invention, the functionality of the test unit is integrated with the OLT (for example is a test card placed in a slot in place of EBC3 or PSU or any suitable location of the OLT), or is part of another network element of the passive optical network (such as PON 101 shown in FIG. 1B). Yet in another example embodiment of the invention, the test unit 140 is not directly coupled to an OLT or within PON 101, but communicatively coupled to the passive optical network (such as PON 101 shown in FIG. 1B) through another communication connection. Yet in another example embodiment of the invention, the test unit 140 is communicatively coupled to a carrier communication network which is communicatively coupled to an uplink card of the OLT.

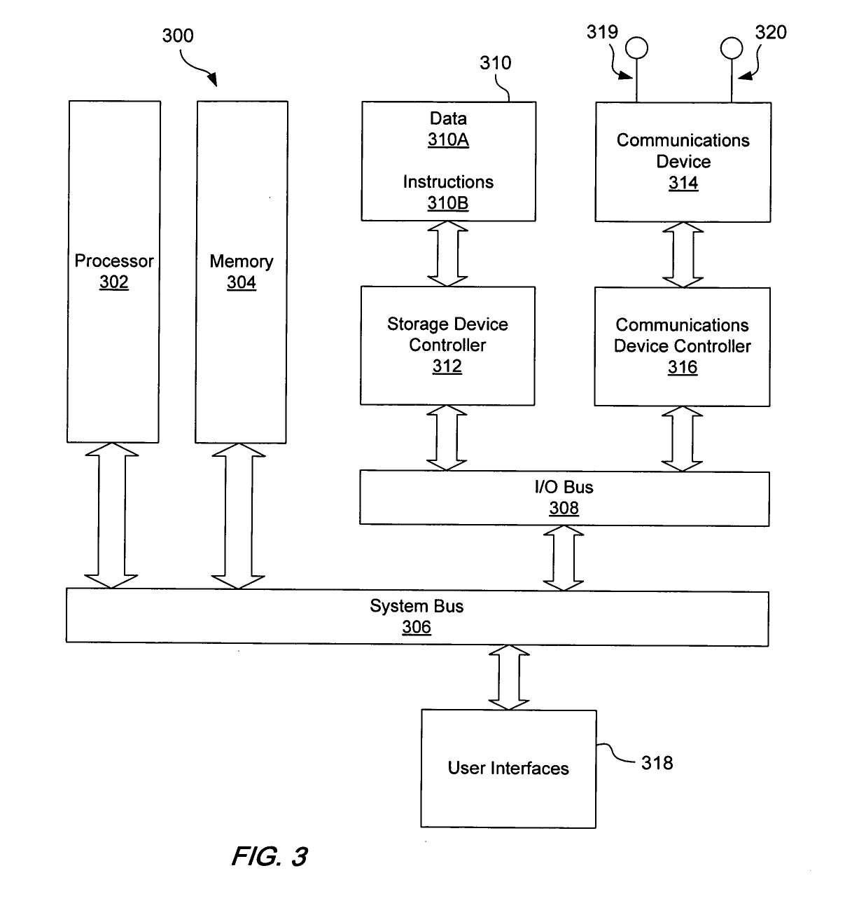

Test unit 140 includes at least two voice line terminations (not shown in FIG. 1B) for each telephony display device used to verify features and services. The test unit and/or OLT (e.g., 102) may include hardware, software or firmware or any combination of hardware, software and firmware (not shown in FIG. 1B) for performing, at least in part, methods described below for verifying voice features and services. The test unit and/or OLT may also include a processor and memory (not shown in FIG. 1B), used to execute instructions in the software and/or firmware. An architecture diagram of an example data processing system or device which, according to an example embodiment, can form a test unit and/or OLT is shown in FIG. 3 described below.

An example embodiment of CPE 110 can include, among other components, at least one telephony display device (such as telephony display device 141 shown in FIG. 1B) communicatively coupled to an ONT (such as ONT 106a shown in FIG. 1B). A telephony display device can be any CPE having a display (such as a Caller ID display), a telephony display device such as a lineman's handset (also known as a Butt set), another type of telephony device having a user-perceptible output interface, or the like.

One challenge in testing call features, particularly for technicians troubleshooting voice issues or installing equipment, is identifying which call features a customer has subscribed to. Access to a service order database can be limited and cumbersome. In addition, technicians are expected to promptly complete installations and address customer issues as quickly as possible. Often, the only voice feature validated by a technician is the existence of dial tone. This leaves other features such as Caller ID, Call Message Waiting Indicator, etc., unverified, and it is often left to the customer to perform “real time” validation.

According to an example embodiment of the invention, the EMS 130 or test unit 140 can acquire, into a database stored thereon, provisioning information including a list of subscribed-to service features from a provider's service order. The EMS or test unit 140 can acquire such provisioning information (using, e.g., Operational Support System (OSS)) from a database such as the service inventory database 150 (shown in FIG. 1B) located at the service provider side. The EMS 130 or test unit 140 can then transmit this information to the ONT (e.g., the ONT 106a of FIG. 1B or ONT 10 of FIG. 1C), via an ONT port. The information can be stored in a local database on the ONT.

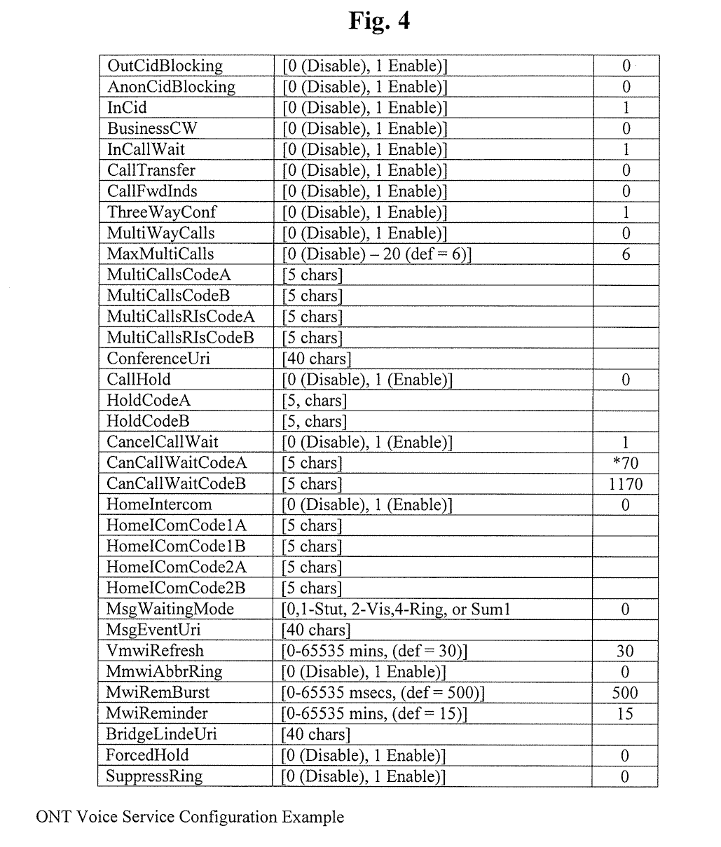

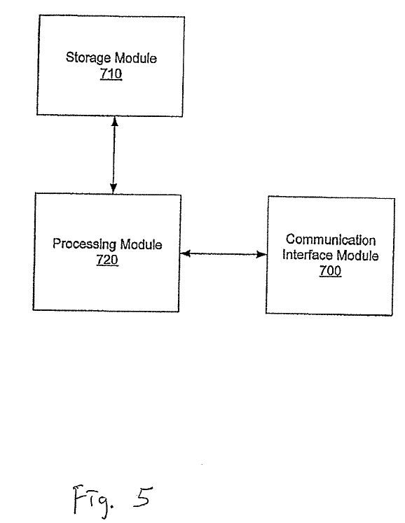

Each service feature (e.g., caller ID, call message waiting, etc.) on an ONT voice port can be identified in the body of an HTTPS XML (eXtensible Markup Language) file exchange. FIG. 4 shows an example of provisioned voice services on an ONT, which can be parsed to determine which service features are enabled and therefore which service features may be tested. The provisioned information can be used to drive an ONT diagnostic user interface (or an interface on the telephony display device 141) to run the selected tests. This can be accomplished without requiring any additional data from the service provider. For example, a technician would not need to query to identify which services have been provisioned for a customer, as this data already exists on the ONT and is used to populate the diagnostic user interface thereof.

The user interface, e.g. at the ONT or on the telephony display device, can enable a technician to easily initiate testing of one or more service features. If the information of what service features the customer has subscribed to are already stored on the ONT, those service features can be tested. If not, or if the information is to be updated, a request for such information is sent from the ONT to the OLT 102 to the EMS 130 to the service inventory database 150. The information is then returned from the service inventory database 150 to the EMS 130 to the OLT 102 to the ONT. The technician can then proceed to initiate the tests and obtain pass/fail confirmation. The ONT can be programmed to test the features stored in its local database.

Methods for configuring a user interface to initiate various tests include but are not limited to initiating the tests locally at the ONT using DTMF, remotely using an Element Management System (EMS), via telephone with a voice response, via the Internet using an IP address, or using a signaling protocol. For example, in the local approach, a field technician can interact with the ONT, directly or indirectly, and menu options can include a selection to test all voice enabled services, or the technician could select a specific test from a menu list. The menu list can be generated dynamically based on the enabled services such as those shown in FIG. 4. Pass/Fail indications for each test can be communicated to the technician via the Caller ID display.

In another approach, the technician can operate from a remote location. If the technician wishes to test voice call features, for example, the tests can be initiated from an EMS (e.g., EMS 130). The EMS can communicate over an ONT Management Control Interface (OMCI) to the ONT. The ONT can initiate the same type of tests available via the DTMF interface. The technician can log and report the results of each call feature.

A brief description of Caller ID functionality and a lineman's handset will now be provided. Caller ID, or calling number identification (CNID) is a telephony intelligent network service that transmits a caller's telephone number, and in some cases the caller's name, to a called party's telephone equipment during a “ringing” signal or when the call is being set up but before the call is answered. Typically, CNID is transmitted digitally. In one example, caller ID information is sent to the called party by a telephone switch as an analog data stream, between a first and second ring, while the telephone unit is still on the hook (e.g., “on-hook”). Single Data Message Format (SDMF) is a type of caller ID which provides the caller's telephone number and the date and time of the call. Multiple Data Message Format (MDMF) is a type of caller ID which, along with the information provided by the SDMF format, can also provide the directory listed name for the particular number.

A lineman's handset, also called a test set or butt set, is a one-piece telephone that integrates an earpiece, a mouthpiece, and a dialing interface. Originally, the dialing interface was a rotary dial, but it is now more commonly a 12-button DTMF keypad. A lineman's handset is commonly used by technicians for testing local loop telephone lines in telephone exchanges. It can be used for installation and troubleshooting, and can hook into the phone system (for example via a pair of alligator clips) anywhere the lines are exposed, such as in a phone jack inside a customer's house, or in the box where a home's telephone wires connect to the company's telephony lines. Whether in the exchange or in the field, a lineman's handset can be used to “butt in” to a telephone circuit using the test leads. This can allow for a technician to, for example, check for dial tone, ring back a number to determine the phone line being worked on, or to place a call. A lineman's handset will typically include basic features including speaker phone, redial, mute, etc.

FIG. 1C is a block diagram of a system illustrating an optical network terminal 10 and a telephony display device 20, according to an example embodiment of the invention. In this example embodiment, the telephony display device 20 is a butt set and is communicatively coupled to ONT 10 via RJ-11 port 14 and cable 19. Display telephony device 20 includes a Caller ID display 22, a key pad 24 for entry of alphanumerics by a user, a speaker 26, and a microphone 28. It should be noted that while in the present example the telephony display device 20 is described as being a butt set which provides a user or technician with the ability to initiate and respond to test requests locally, such actions can also be performed in other ways, such as remotely via an EMS, through a voice response via a telephone or other type of CPE, through the Internet using direct communication with the ONT via the ONT's WAN IP address, etc. In the Internet example, the communication path can be a secure communication channel, e.g. HTTPS to the ONT, and menus for selecting and conducting tests and test results themselves can be displayed on a web page, for example.

ONT 10 has additional ports 12 for its other functionality, and can be communicatively coupled to an OLT (not shown) of a passive optical network via cable 11. The ONT 10 can include hardware, software or firmware or any combination of hardware, software and firmware for performing ONT functionality and for performing, at least in part, the methods described below for verifying voice features and services. The ONT 10 also includes a processor and memory 15. The process is used to execute instructions in the software and/or firmware, stored in memory 15.

In an example embodiment, the ONT 10 uses a standard Caller-ID process (e.g., based on GR-30-CORE Frequency Shift Keying) for signaling to the telephony display device 20, from which a menu system can be displayed via a Caller ID display 22. The return signaling can be readily accomplished using a standard key pad (or other input interface), the DTMF signals being formatted in a Caller ID-compatible format (e.g. GR-30 compliant messaging from a CPE to an SPCS (the ONT)). The signaling is then received, converted and processed by the ONT 10. Accordingly, the ONT 10 can also include converters for converting data to and from the ONT processor between its normal processing format and the inbound Caller ID-compatible (i.e. SPCS to CPE for the ONT 10 to telephony display device link) and outbound signaling (e.g. CPE to SPCS for the telephony display device to ONT link or DTMF) formats.

An example embodiment of the invention implements methods to verify features and services described below, in the form of a user interface that can utilize: a display (such as the Caller ID display 22 shown in FIG. 1C), a speaker (such as speaker 26 shown in FIG. 1C) or another type of output user-interface, a microphone (such as microphone 28 shown in FIG. 1C) or another type of input user-interface and/or a key pad (such as key pad 24 shown in FIG. 1C) of a telephony display device, that present(s) information to guide a field technician through various features and services verification tests. The field technician can be presented with instructions in a visual form (such a light indicator or a prompt on a Caller ID display), in a sound form (such as a particular tone or bell), or via another user-perceptible indicator (collectively and hereinafter referred to as a “telephony device indicator”), and the field technician can respond to the instructions by entering signals via the key pad, speaking a response into the microphone of the telephony display device or by performing another action (such as making a phone call or other communication).

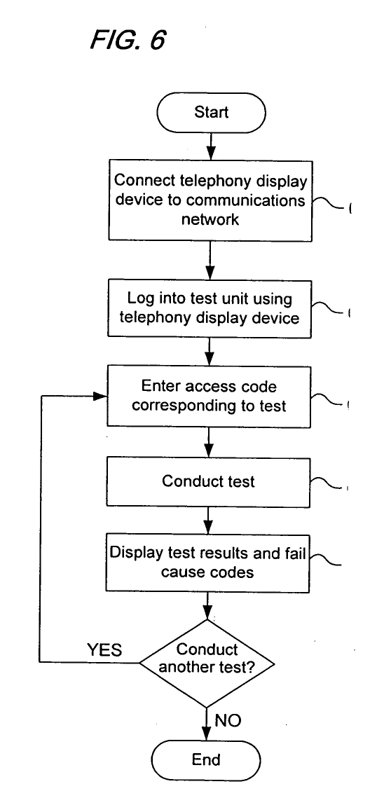

FIG. 6 is a flow diagram that illustrates a method in accordance with an example embodiment of this invention for locally verifying a media service feature in a communication network provided to a subscriber terminal. The communication network may be, for example, any FTTx network. At block 600, to initiate a media service feature verification test, the technician communicatively couples a telephony display device (e.g., the telephony display device 141 shown in FIG. 1B or device 20 of FIG. 1C) to the communications network via an ONT (e.g., the ONT 106a shown in FIG. 1B or ONT 10 of FIG. 1C). The telephony display device can be communicatively coupled to the ONT through, for example, a voice port (e.g., 12 of FIG. 1C) on the ONT or through another suitable interface. At block 602, the technician logs into the test unit (e.g., test unit 140 of FIG. 1B) by, for example, entering or dialing the test unit's directory (e.g. ten digit) number or code into the telephony display device 141 (which communicates with test unit 140 to effect login). Login could also be accomplished using a mobile information processing apparatus communicating with the test unit 140, for example via the Internet.

At block 604, the technician enters into the telephony display device (for example using a key pad thereof) a test access code corresponding to the feature or service verification test to be performed. In an example embodiment of the invention, a test access code is a unique Dual-Tone Multi-Frequency (DTMF) digit sequence, which the test unit interprets as a test type (e.g., voice feature test). (After the technician logs on and enters the test access code, the ONT can respond by entering a diagnostic mode in which the ONT disallows any requests (such as a request to make a phone call) by a customer at any CPE communicatively coupled to the ONT.) The test access code can correspond for example to a particular test or to a generic “test all customer call features” test desired to be performed by the technician. In the case of a “test all customer call features” test request, as an example a service provider's provisioning database can be accessed when the test is performed to verify which call features are being subscribed to by a particular customer or on a particular communication line.

At block 606, the technician conducts a test as will be described below for verifying a media service feature provided to the subscriber terminal, using the test unit (e.g., 140). The method can verify all media features or services on the communication path associated with the subscriber terminal. At block 608, the test results (e.g. pass/fail) are returned to the technician by, for example, displaying them on the display of the telephony display device. The test results may also include, for example, a fail cause code. It should be noted that, in one example embodiment, the ONT and the test unit can be programmed to initiate and perform the test of each call feature automatically and without any further interaction by the field technician, although in other embodiments further user interaction may be employed. At block 610, the test unit queries the technician via the display on the telephony display device as to whether another test is to be conducted. If so, the method returns to block 604, and if not the method ends, wherein the technician specifies either selection by operating the keypad or the like of the telephony display device 141.

In general, DTMF signaling is used for telephone signaling over a line in the voice-frequency band to a call switching center. The version of DTMF used for telephone tone dialing (i.e. “Touch-Tone”) is standardized by ITU-T Recommendation Q.23. Other multi-frequency systems are often used for signaling internal to the telephone network. DTMF is typically used for most call setups to the telephone exchange.

The following describes example methods of the invention for verifying various common features and services. Although example methods for verifying certain features and services are identified, it can be understood by those skilled in the art in view hereof that various changes in form and details may be made to these methods without departing from the scope of the example embodiments of the invention, and that verification tests for other features or services may be made based on these methods. Furthermore, although the example methods are described herein in the context of being performed in conjunction with the ONT 106a, telephony display device 141, OLT 102, EMS 130, and passive optical network 101 shown in FIG. 1B, it can be understood by those skilled in the art in view hereof that the methods may be employed or performed by other suitable network components instead, or in any type of ONT, telephony display device, OLT, EMS, or passive optical network.

The following example embodiments of the invention describe ways to automate the verification of various common voice features and services such as, for example, Caller ID and Call Waiting. However, other features or services could be automatically verified with minor modification. As but one example, an Automatic Call Screening feature could be validated by extending a prompt to a field technician to enter a desired number to be screened, and programming the test unit to simulate a call from the device associated with that desired number.

The following example embodiments of the invention also describe methods in which a field technician can manually initiate each test, perform certain actions (such as verifying Caller ID response) and terminate the test. These methods could also be performed automatically by an ONT (such as the ONT 106a shown in FIG. 1B) and a test unit (such as the test unit 140 shown in FIG. 1B).

Furthermore, these methods can be performed remotely at an EMS (such as the EMS 130 shown in FIG. 1B) for example by typing at the EMS a command corresponding to a particular test request test or a generic “test customer call features” test request. The ONT and test unit can be programmed to initiate and perform the test of each call feature automatically and without any interaction by a technician. The test results or any fail cause code(s) can be returned to and displayed on the EMS.

While the following describes examples of tests that may be performed, it is of course to be understood that the invention is not limited only to the examples presented.

### Caller ID Example Embodiment Test

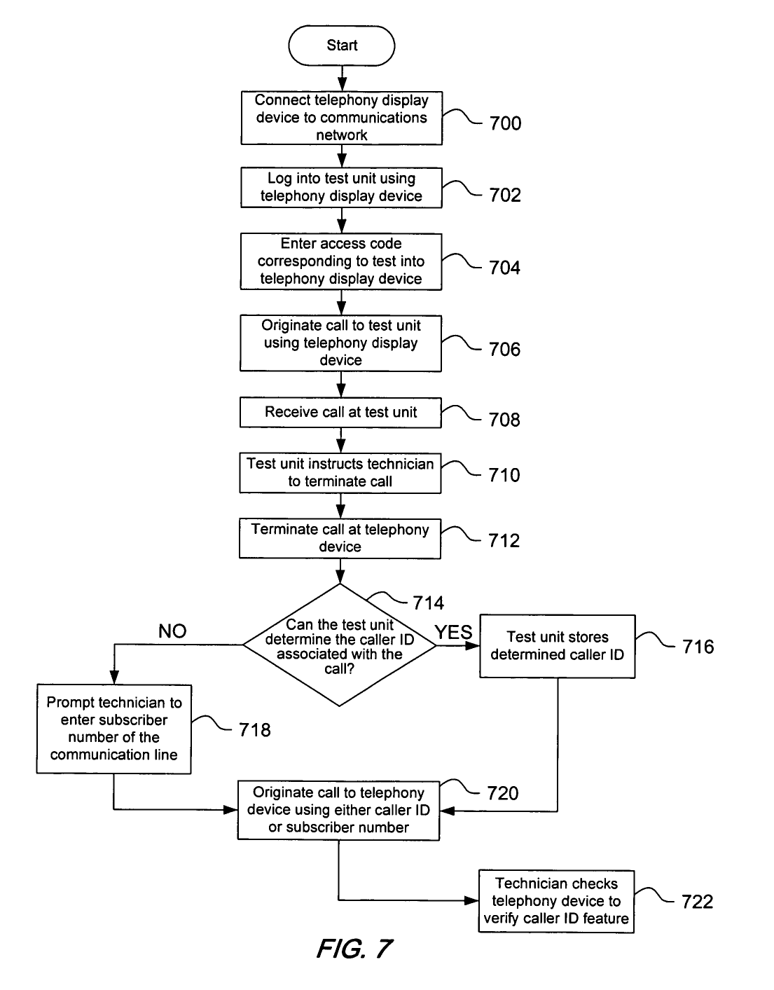

FIG. 7 is a flow diagram that illustrates a method for verifying Caller ID functionality in accordance with an example embodiment of this invention. It is noted that blocks 700-704 may correspond to blocks 600-604 of the method of FIG. 6, respectively, and blocks 706-722 together represent an example of the test referred to in block 606 of FIG. 6.

At block 700, to initiate the test a technician communicatively couples a telephony display device (e.g., the telephony display device 141 shown in FIG. 1B or device 20 of FIG. 1C) to the communications network (such as an FTTx network) via an ONT (e.g., the ONT 106a shown in FIG. 1B or the ONT 10 of FIG. 1C). At block 702 the technician logs into the test unit (e.g., test unit 140 of FIG. 1B) to initiate the test with the test unit 140 by, for example, entering or dialing the directory (e.g. ten digit) number or code of the test unit 140 using the telephony display device 141 (which communicates with test unit 140 to effect login). At block 704, the technician enters, into the telephony display device 141, a DTMF digit sequence or test access code corresponding to a Caller ID test request.

At block 706 the technician is prompted by the test unit 140, at the telephony display device 141 through for example a telephony device indicator (e.g., test unit 140 communicates with device 141 to effect the indicator), to originate a call to the test unit 140, and the technician does so using the telephony display device 141. At block 708 the test unit 140 receives the call and, at block 710, the test unit 140 instructs the technician, through a telephony device indicator of device 141, to terminate the call. At block 712 the technician terminates the call by placing the telephony display device 141 on hook.

At block 714 the test unit 140 determines whether the Caller ID associated with the call can be determined (using known techniques) from Caller ID information received when the test unit 140 was accessed by the telephony display device 141. If the Caller ID can be so determined (“YES” at block 714), then the method proceeds to block 716 and the test unit 140 stores, for example in a memory located therein, the determined Caller ID information. If, on the other hand, the Caller ID cannot be so determined (“NO” at block 714) (for example the procedure for determining the Caller ID determines that the communication line associated with the telephony display device 141 is marked private, e.g., the Caller ID information is marked unknown or private), then at block 718 the test unit 140 prompts the technician, for example through a telephony device indicator of device 141, to enter the subscriber (e.g. ten digit) number of the communication line associated with the telephony display device 141.

At block 720, the test unit 140 then originates a call back to the telephony display device 141 by utilizing either the Caller ID information previously received when the test unit 140 was accessed by the telephony display device 141 or the subscriber number entered by the technician. At block 722 the technician verifies that the Caller ID feature on the communication line associated with the telephony display device 141 is working properly by, for example, checking that a telephony device indicator at the telephony display device 141, performs caller ID operation and shows the Caller ID information of the test unit 140.

In this manner, the technician can verify that the Caller ID functionality provided to the subscriber terminal is operational.

### Call Waiting Example Embodiment Test

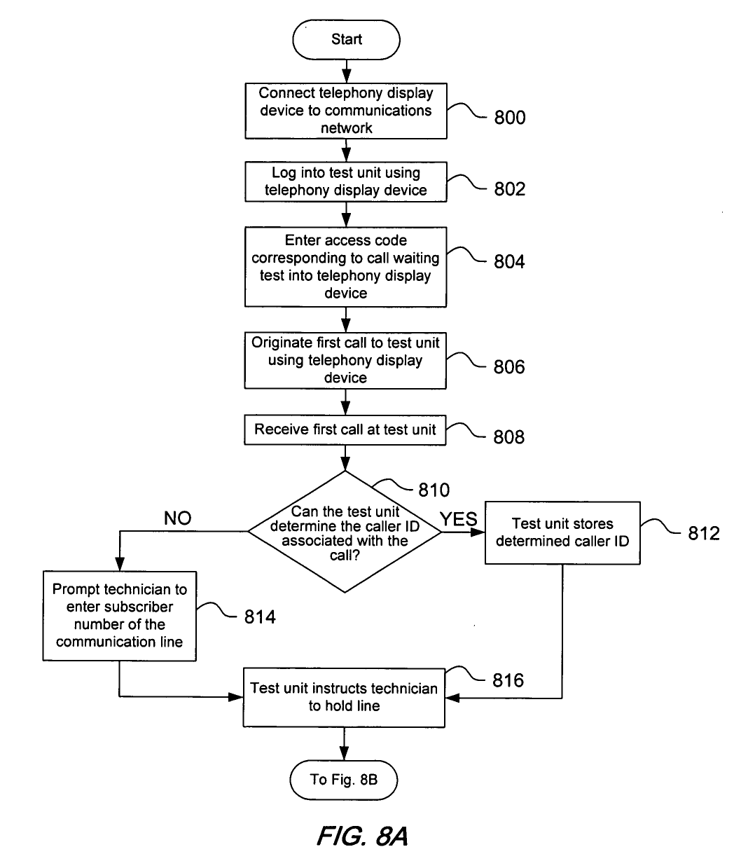

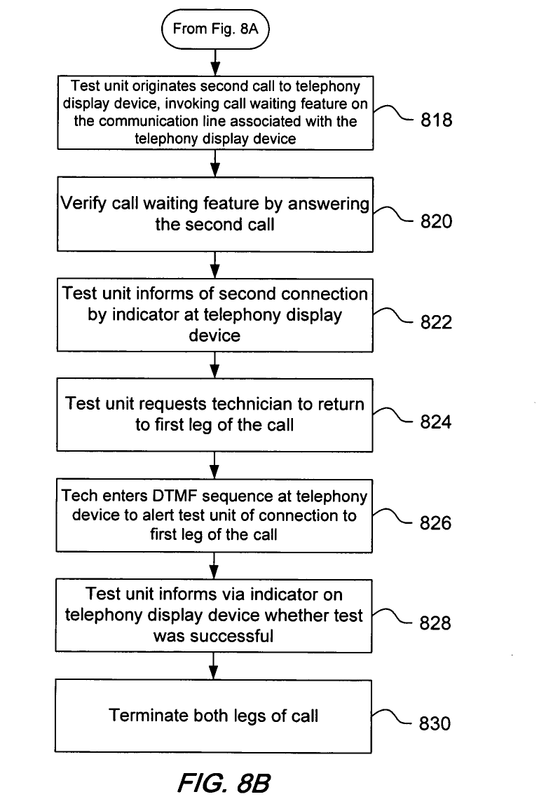

FIGS. 8A and 8B show a flow diagram that illustrates a method for verifying Call Waiting functionality in accordance with an example embodiment of this invention. It is noted that blocks 800-804 may correspond to blocks 600-604 of the method of FIG. 6, respectively, and blocks 806-830 together represent an example of the test referred to in block 606 of FIG. 6.

At block 800, to initiate the test a technician communicatively couples a telephony display device (e.g., the telephony display device 141 shown in FIG. 1B or device 20 of FIG. 1C) to the communications network (such as an FTTx network) via an ONT (e.g., ONT 106a shown in FIG. 1B or ONT 10 of FIG. 1C). At block 802 the technician logs into the test unit (e.g., test unit 140 of FIG. 1B) to initiate the test with the test unit 140 by, for example, entering or dialing the directory (e.g. ten digit) number or code of the test unit 140 using the telephony display device 141 (which communicates with the test unit 140 to effect the login). At block 804, the technician enters, into the telephony display device 141, a DTMF digit sequence or test access code corresponding to a Call Waiting test request. At block 806 the technician is prompted by the test unit 140, at the telephony display device 141 through for example a telephony device indicator (e.g., test unit 140 communicates with device 141 to effect the indicator), to originate a first call to the test unit 140, and the technician does so using the telephony display device 141.

At block 808 the test unit 140 receives the first call and, at block 810, determines whether the caller ID associated with the first call can be determined (using known techniques) from Caller ID information received when the test unit 140 was accessed by the telephony display device 141. If the Caller ID can be so determined (“YES” at block 810), then the method proceeds to block 812 and the test unit 140 stores, for example in a memory located therein, the determined Caller ID information. If, on the other hand, the Caller ID cannot be so determined (“NO” at block 810) (for example the procedure for determining the Caller ID determines that the communication line associated with the telephony display device 141 is marked private, e.g., the Caller ID information is marked unknown or private), then at block 814 the test unit 140 prompts the technician, for example through a telephony device indicator, to enter the subscriber (e.g., ten digit) number of the communication line associated with the telephony display device 141.

At block 816 the test unit 140 instructs the technician to hold the line. At block 818 (FIG. 8B), the test unit 140 originates a second call to the telephony display device 141 by utilizing either the caller ID information previously received when the test unit 140 was accessed by the telephony display device 141 or the subscriber number entered by the technician. The second call from the test unit 140 to the telephony display device 141 invokes the Call Waiting feature on the communication line associated with the telephony display device 141. At block 820, the field technician can then verify the Call Waiting feature by answering the second call when the Call Waiting indication (e.g., Call Waiting tone or Call Waiting light indicator) is presented at the telephone display device 141.

At block 822 the test unit 140 informs the technician of the second connection (i.e. the answered connection) by effecting a voice message or a telephony device indicator at the telephony display device 141. At block 824, the test unit requests the technician to perform a hook switch flash (which is a known technique of transferring to another line) to return to the original (first) leg of the call and, at block 826, enter a DTMF digit sequence to alert the test unit 140 of the connection to the first leg of the call. At block 828 the test unit 140 can then inform the field technician, through a telephony device indicator, whether the test has completed successfully and, at block 830, terminate both legs of the Call Waiting call.

In this manner, the technician can verify that the Call Waiting functionality provided to the subscriber terminal is operational.

### Call Waiting Caller ID Example Embodiment Test

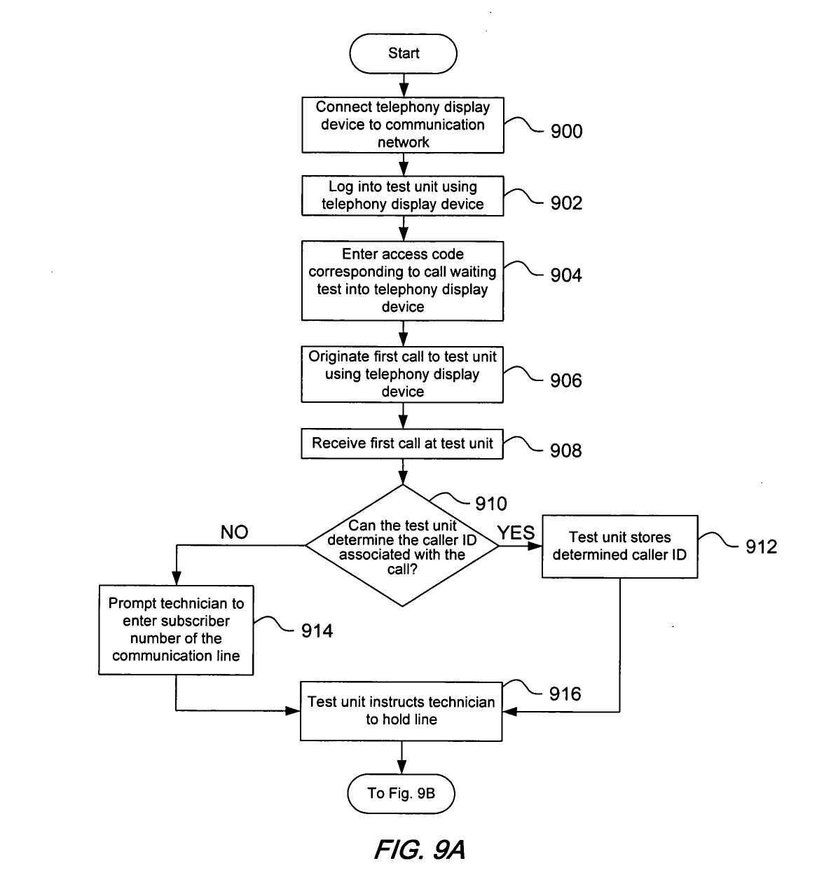

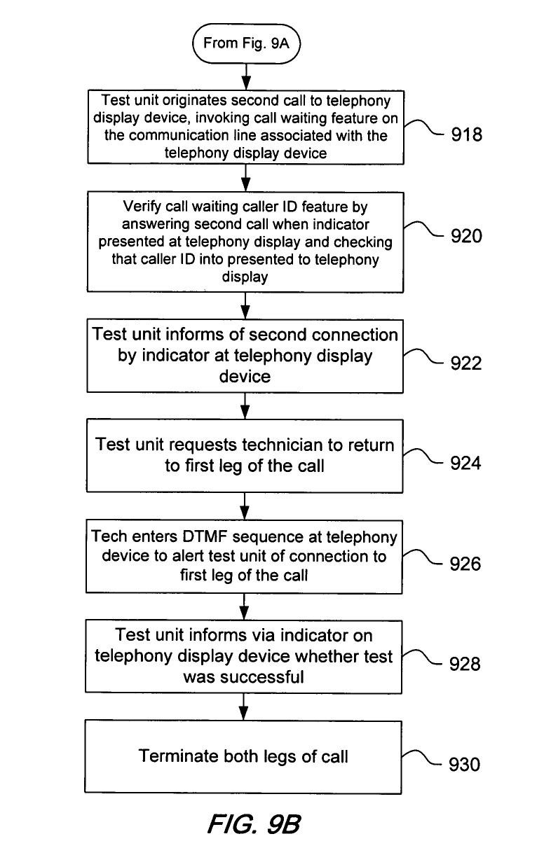

FIGS. 9A and 9B show a flow diagram that illustrates a method for verifying Call Waiting Caller ID functionality in accordance with an example embodiment of this invention. It is noted that blocks 900-904 may correspond to blocks 600-604 of the method of FIG. 6, respectively, and blocks 906-930 together represent an example of the test referred to in block 606 of FIG. 6.

At block 900, to initiate the test a technician communicatively couples a telephony display device (e.g., the telephony display device 141 shown in FIG. 1B or device 20 of FIG. 1C) to the communications network (such as an FTTx network) via an ONT (e.g., ONT 106a shown in FIG. 1B or ONT 10 of FIG. 1C). At block 902 the technician logs into the test unit (e.g., test unit 140 of FIG. 1B) to initiate the test with the test unit 140 by, for example, entering or dialing the directory (e.g. ten digit) number or code of the test unit 140 using the telephony display device 141 (which communicates with test unit 140 to effect the login). At block 904, the technician enters, into the telephony display device 141, a DTMF digit sequence or test access code corresponding to a Call Waiting Caller ID test request. At block 906 the technician is prompted by the test unit 140, at the telephony display device 141 through for example a telephony device indicator (e.g., test unit 140 communicates with device 141 to effect the indicator), to originate a first call to the test unit 140, and the technician does so using the telephony display device 141.

At block 908 the test unit 140 receives the first call and, at block 910, determines whether the caller ID associated with the first call can be determined (using known techniques) from Caller ID information received when the test unit 140 was accessed by the telephony display device 141. If the Caller ID can be so determined (“YES” at block 910), then the method proceeds to block 912 and the test unit 140 stores, for example in a memory located therein, the determined Caller ID information. If, on the other hand, the Caller ID cannot be so determined (“NO” at block 910) (for example the procedure for determining the Caller ID determines that the communication line associated with the telephony display device 141 is marked private, e.g., the Caller ID information is marked unknown or private), then at block 914 the test unit 140 prompts the technician, for example through a telephony device indicator of device 141, to enter the subscriber (e.g., ten digit) number of the communication line associated with the telephony display device 141.

At block 916 the test unit 140 instructs the technician to hold the line. At block 918, the test unit 140 originates a second call to the telephony display device 141 by utilizing either the caller ID information previously received when the test unit 140 was accessed by the telephony display device 141 or the subscriber number entered by the technician. The second call from the test unit 140 to the telephony display device 141 invokes the Call Waiting feature on the communication line associated with the telephony display device 141. At block 920, the technician can then verify the Call Waiting Caller ID feature by answering the second call when the Call Waiting indication (e.g., Call Waiting tone or Call Waiting light indicator) is presented at the telephone display device 141 and checking that the Caller ID information was presented to the telephony display device 141.

At block 922 the test unit 140 informs the technician of the second connection (i.e. the answered connection) by effecting a voice message or a telephony device indicator at the telephony display device 141. At block 924, the test unit requests the technician to perform a hook switch flash (which is a known technique of transferring to another line) to return to the original (first) leg of the call and, at block 926, enter a DTMF digit sequence to alert the test unit 140 of the connection to the first leg of the call. At block 928 the test unit 140 can then inform the field technician, through a telephony device indicator at device 141, whether the test has completed successfully and, at block 830, terminate both legs of the Call Waiting call.

In this manner, the technician can verify that the Call Waiting Caller ID functionality provided to the subscriber terminal is operational.

### Message Waiting Indicator Example Embodiment Test

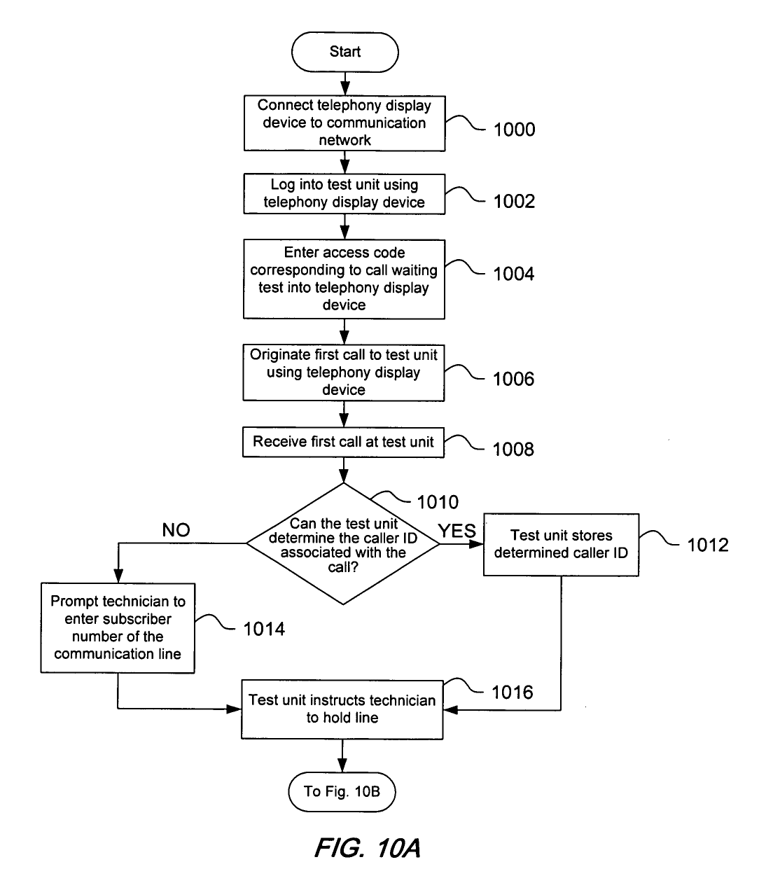

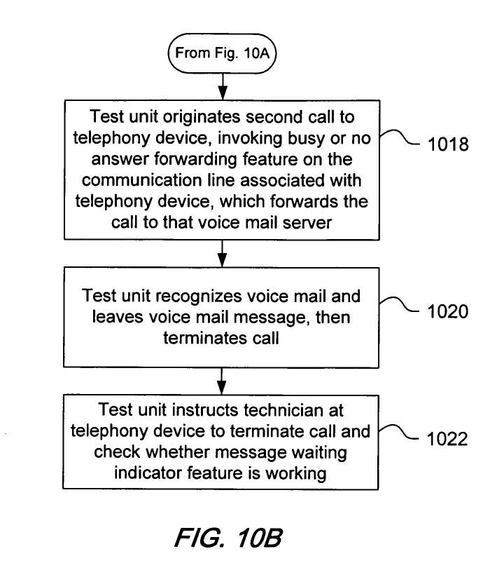

FIGS. 10A and 10B illustrate a flow diagram that illustrates a method for verifying Message Waiting Indicator functionality in accordance with an example embodiment of this invention. It is noted that blocks 1000-1004 may correspond to blocks 600-604 of the method of FIG. 6, respectively, and blocks 1006-1022 together represent an example of the test referred to in block 606 of FIG. 6.

At block 1000, to initiate the test a technician communicatively couples a telephony display device (e.g., the telephony display device 141 shown in FIG. 1B or device 20 of FIG. 1C) to the communications network (such as an FTTx network) via an ONT (e.g., the ONT 106a shown in FIG. 1B or the ONT 10 of FIG. 1C). At block 1002 the technician logs into the test unit (e.g., test unit 140 of FIG. 1B) to initiate the test with the test unit 140 by, for example, entering or dialing the directory (e.g. ten digit) number or code of the test unit 140 using the telephony display device 141 (which communicates with unit 140 to effect the login). At block 1004, the technician enters, into the telephony display device 141, a DTMF digit sequence or test access code corresponding to a Message Waiting Indicator test request. At block 1006 the technician is prompted by the test unit 140, at the telephony display device 141 through for example a telephony device indicator of device 141, to originate a first call to the test unit 140, and the technician does so using the telephony display device 141.

At block 1008 the test unit 140 receives the call. At block 1010 the test unit 140 determines whether the Caller ID associated with the call can be determined (using known techniques) from Caller ID information received when the test unit 140 was accessed by the telephony display device 141. If the Caller ID can be so determined (“YES” 1010), then the method proceeds to block 1012 and the test unit 140 stores, for example in a memory located therein, the determined Caller ID information. If, on the other hand, the Caller ID cannot be so determined (“NO” at block 1010) (for example the procedure for determining the Caller ID determines that the communication line associated with the telephony display device 141 is marked private, e.g., the Caller ID information is marked unknown or private), then at block 1014 the test unit 140 prompts the technician, for example through a telephony device indicator at device 141, to enter the subscriber (e.g. ten digit) number of the communication line associated with the telephony display device 141.

At block 1016 the test unit 140 instructs the technician to hold the line. At block 1018, the test unit 140 then originates a second call to the telephony display device 141 by utilizing either the Caller ID information previously received when the test unit 140 was accessed by the telephony display device 141 or the subscriber number entered by the technician. The second call to the telephony display device 141 invokes the busy or no answer forwarding feature on the communication line associated with the telephony display device 141, which forwards the call to the voice mail server of the communication line associated with the telephony display device 141. At block 1020, once voice (e.g., of the voice mailbox) is recognized by the test unit 140, the test unit 140 leaves a voice mail message of a predetermined minimum amount of time (e.g., a minimum of 3 seconds) and then terminates the call. At block 1022 the test unit 140 then instructs the field technician, through a telephony device indicator at the telephony display device 141, to terminate the call and check that the Message Waiting Indicator feature of the communication line associated with the telephony display device 141 is working properly by, for example, checking that there is a message waiting indicator (e.g., a stutter dial tone and/or a Message Waiting light indicator) at the telephony display device 141.

In this manner, the technician can verify that the Message Waiting Indicator functionality provided to the subscriber terminal is operational.

It is noted that the example embodiments of the invention shown in FIGS. 6-11 can be performed automatically, for example using the signaling information that is exchanged, without user interaction. For example, an intelligent ONT (e.g., the ONT 106a shown in FIG. 1B or the ONT 10 shown in FIG. 1C) can be programmed to carry out the steps of the methods in conjunction with the test unit 140.

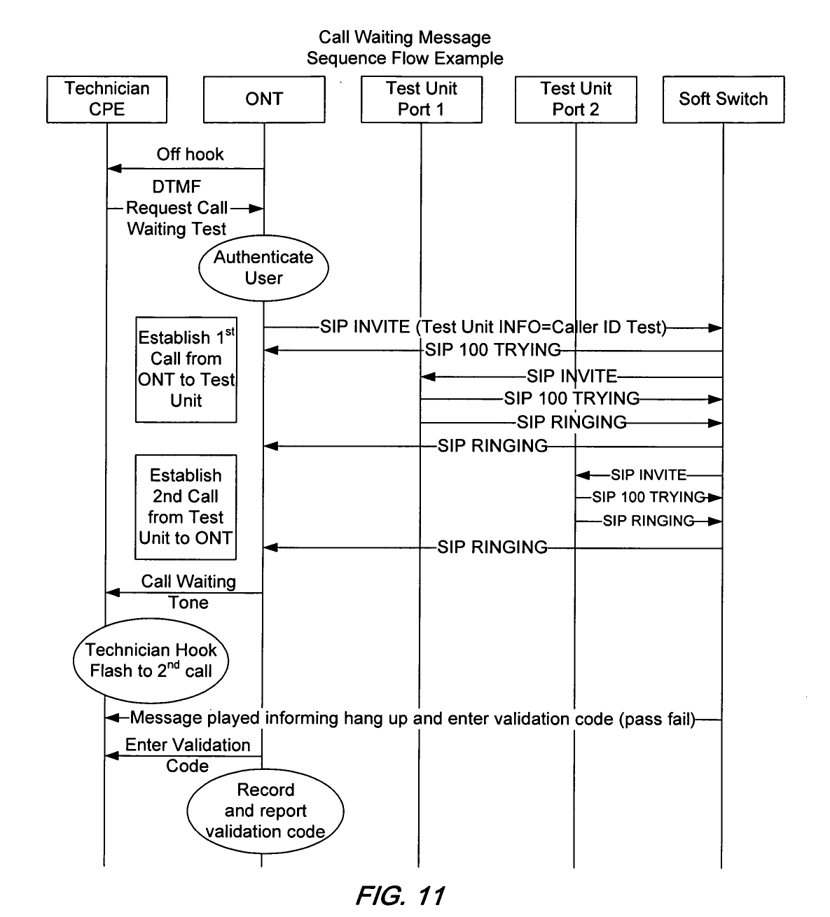

FIG. 11 is a signaling diagram that illustrates a method for testing media service features in accordance with an example embodiment of the invention. The method includes sending/receiving calls to/from an ONT (e.g., the ONT 106a shown in FIG. 1B or the ONT 10 of FIG. 1C) and to/from a test unit (such as test unit 140 of FIG. 1B). The ONT automatically interprets and validates compliance to each feature.

In FIG. 11, a field technician communicatively couples a telephony display device (such as telephony display device 141) to the ONT voice port and enters an authentication code to initiate local diagnostics. The technician selects, for example, a “Validate Call Waiting” feature from a menu provided on the display of the telephony display device 141 or on the ONT interface. The ONT initiates a call to the test unit 140 and identifies in the body of the message (INFO) that this is a call to verify Caller Waiting. The test unit 140 is signaled to establish the initial call. The test unit 140 plays an audible sequence, e.g. a message or a series of tones, so that the technician can hear that the first call has been established. The test unit 140 is then requested to establish a second call from the test unit 140 to the ONT under test. The ONT forwards an audible alert to the technician that a call is waiting. The technician completes a hook flash and answers the second call. The test unit plays a message to the technician instructing the technician to terminate all calls and enter verification DTMF tones to complete the test. The ONT responds via the Call Waiting field that this test was complete.

In this manner, it can be verified that the Call Waiting functionality provided to the subscriber terminal is operational.

According to an example embodiment of the invention, various statistical reports can be generated which detail and report any and all tests conducted using the methods described herein, as well as the results thereof and any reasons for failure. In this way, accurate reporting logs can be created and stored for various purposes, including record keeping, cost effectiveness, and diagnosis. The tests results can be stored for example in the EMS 130, the ONT, or the test unit 140, and retrieved therefrom. The test results can also be communicated to a service provider database using (for example) OSS or the Internet, etc.

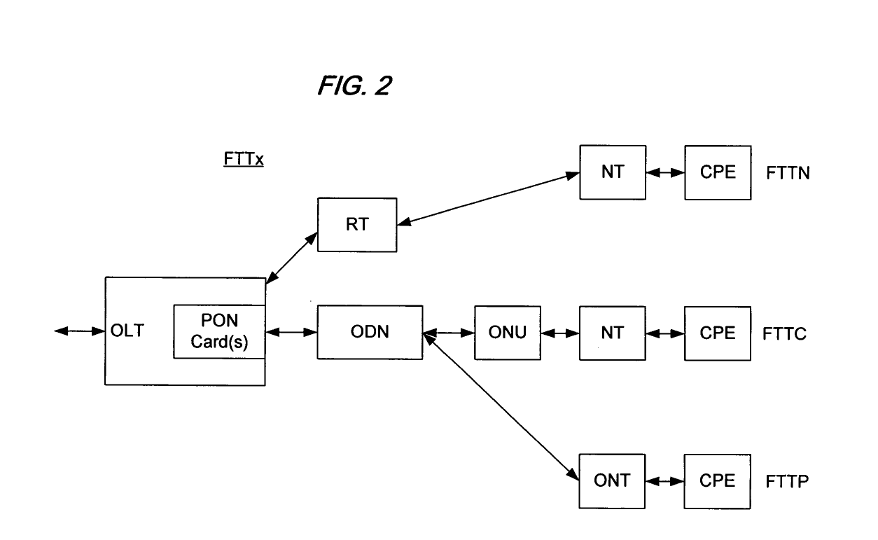

FIG. 5 is a logical diagram of modules in accordance with an example embodiment of the present invention. The modules may be of a data processing system or device 300, which, according to an example embodiment, can form individual ones of the components 102, 106a-n, 130, 140, and 141 of FIG. 1B, components 10 and 20 of FIG. 1C, and the ONU of FIG. 2. The modules may be implemented using hardcoded computational modules or other types of circuitry, or a combination of software and circuitry modules. Communication interface module 700 controls communication device 314 by processing interface commands. Interface commands may be, for example, commands to send data, commands to communicatively couple with another device, or any other suitable type of interface command. Storage device module 710 stores and retrieves data in response to requests from processing module 720. Processing module 720 performs the procedures as described herein. For example, processing module 720 may perform a test in connection with FIGS. 6-11. After performing the test, processing module 720 retrieves data representing the results of the test from storage module 710 and sends a response, based on that data, via communication interface module 700.

FIG. 3 is an architecture diagram of an example data processing system or device 300, which, according to an example embodiment, can form individual ones of the components ONU of FIG. 2, components 110, 130, 102, 104a-n, 140, and 106a-n of FIG. 1B, and/or another example embodiment of component 10 and/or 20 of FIG. 1C. Data processing system 300 includes a processor 302 coupled to a memory 304 via system bus 306. Processor 302 is also coupled to external Input/Output (I/O) devices (not shown) via the system bus 306 and an I/O bus 308, and at least one input/output user interface 318. Processor 302 may be further coupled to a communications device (interface) 314 via a communications device controller 316 coupled to the I/O bus 308. Processor 302 uses the communications device 314 to communicate with a network, such as, for example, a network as shown in FIG. 1B, and the device 314 may have one or more input and output ports. In the case of at least the ONTs 106a-n, device 314 has data port 319 operably coupled to a network (e.g., PON 101) for sending and receiving data, and voice services data port 320 operably coupled to customer premises equipment (e.g., 110) for sending and receiving voice data, but device 314 may also have one or more additional input and output ports. A storage device 310 having a computer-readable medium is coupled to the processor 302 via a storage device controller 312 and the I/O bus 308 and the system bus 306. Processor 302 also can include an internal clock (not shown) to keep track of time, periodic time intervals, and the like.

The input/output user interface 318 may include, for example, at least one of a keyboard, a mouse, a trackball, touch screen, a keypad, and/or any other suitable type of user-operable input device(s), and at least one of a video display, a liquid crystal or other flat panel display, a speaker, a printer, and/or any other suitable type of output device for enabling a user to perceive outputted information.

Storage device 310 having a computer-readable medium is coupled to the processor 302 via a storage device controller 312 and the I/O bus 308 and the system bus 306. The storage device 310 is used by the processor 302 and controller 312 to store and read/write data 310a, and to store program instructions 310b used to implement the procedures described herein and shown in FIGS. 6-10B. The storage device 310 also stores various routines and operating programs (e.g., Microsoft Windows, UNIX/LINUX, or OS/2) that are used by the processor 302 for controlling the overall operation of the system 300. At least one of the programs (e.g., Microsoft Winsock) stored in storage device 310 can adhere to TCP/IP protocols (i.e., includes a TCP/IP stack), for implementing a known method for connecting to the Internet or another network, and may also include web browser software, such as, for example, Microsoft Internet Explorer (IE) and/or Netscape Navigator, for enabling a user of the system 300 to navigate or otherwise exchange information with the World Wide Web (WWW).

In operation, processor 302 loads the program instructions 310b from the storage device 310 into the memory 304. Processor 302 then executes the loaded program instructions 310b to perform any of the example methods described herein, for operating the system 300 (which forms individual ones of the components 110, 130, 102, 104a-n, 106a-n, and 140).

While this invention has been particularly shown and described with references to example embodiments thereof, it will be understood by those skilled in the art that various changes in form and details may be made therein without departing from the scope of the invention. Thus, the invention should not be limited by any above-described example embodiment, but should be defined only in accordance with the following claims and their equivalents.

For example, although described as “cards” herein, it should be understood that PON cards, OLT cards, or ONT cards may be systems or subsystems without departing from the principles disclosed hereinabove.

Furthermore, actual hardware, software and/or firmware in an OLT, test unit or telephony display device may vary depending upon the passive optical network in which these devices are used, requirements of the end-user using these devices and/or the particular voice features and services being verified. The actual software and/or firmware may be downloaded onto these devices at the factory, in the field or from a remote site.

Although described in reference to a passive optical network, the same or other example embodiments of the invention may be employed in any communications network, such as an active optical network, data communications network, or wireless network (e.g., between handheld communications units and a base transceiver station). Furthermore, example embodiments of the invention may be employed in all types of passive optical networks, such as APON, BPON, GPON, WDM-PON, EPON, or any PON derivative.

Those of ordinary skill in the art should recognize that example methods of the invention may be embodied in hardware, software or firmware, a combination of hardware, software and/or firmware, or software that includes a computer usable medium. Such a computer usable medium can include, but is not limited to, a readable memory device, such as a solid state memory device, a hard drive device, a CD-ROM, a DVD-ROM, an optical disk, a magneto-optical disk, or a computer diskette, having stored computer-readable program code segments. The computer readable medium can also include a communications or transmission medium, such as a bus or a communications link, either optical, wired, or wireless, carrying program code segments as digital or analog data signals.

Accordingly, software embodiments of the invention may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include the types of computer usable medium listed above or other types of media/machine-readable medium suitable for storing or transmitting electronic instructions. The techniques described herein are not limited to any particular software configuration. They may find applicability in any computing or processing environment. The terms “computer readable medium,” “machine accessible medium,” or “machine readable medium” used herein shall include any medium that is capable of storing, encoding, or transmitting a sequence of instructions for execution by the computer or machine and that cause the computer or machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating, for some example embodiments, that the execution of the software by a processing system causes the processor to perform an action to produce a result.

1. A method for verifying a media service feature provided to at least one subscriber terminal in a communication network, comprising:
connecting a communication device to the network;
logging into a test unit communicatively coupled to the network using the communication device;
entering into the communication device an access code corresponding to a test for verifying a service; and
conducting the test for verifying the service, corresponding to the access code.

2. The system as set forth in claim 1, wherein the communication device is a telephony display device.

3. The system as set forth in claim 1, wherein the communication device is communicatively coupled to the network through an Optical Network Terminal.

4. The system as set forth in claim 1, wherein the test unit is integrated with an Optical Line Terminal and stores a program having instructions that effect the conducting of the test.

5. The system as set forth in claim 1, wherein the logging includes entering a directory code corresponding to the test unit.

6. The system as set forth in claim 1, wherein the access code is a Dual-Tone Multi-Frequency sequence.

7. The method as set forth in claim 1, wherein the test includes communicating between the test unit and the communication device.

8. The method as set forth in claim 1, wherein the conducting is performed automatically.

9. The method as set forth in claim 1, wherein the test verifies all media service features on a communication path associated with the at least one subscriber terminal.

10. The method as set forth in claim 1, wherein the conducting includes performing the test remotely from an Element Management System (EMS).

11. An apparatus for verifying a service in a communication network, comprising:
a communication interface; and
a test component operable to communicate with the network by way of the communication interface to conduct a test for verifying a service provided to at least one subscriber terminal via the network.

12. The apparatus as set forth in claim 11, wherein the test is performed automatically.

13. A system for verifying a service in a communication network, comprising:
an apparatus for verifying a service in the network, including a communication interface and a test component operable to communicate with the network by way of the communication interface to conduct the test for verifying a service provided to at least one subscriber terminal via the network; and
a communication device communicatively coupled to the network and being operable to communicate with the apparatus to conduct the test.

14. The system as set forth in claim 13, wherein the test is performed automatically.

15. The system as set forth in claim 13, wherein the apparatus comprises a test unit integrated with an Optical Line Terminal storing a program having instructions that effect the conducting of the test.

16. The system as set forth in claim 13, wherein the communication device is a telephony display device.

17. The system as set forth in claim 13, wherein the apparatus is an Element Management System (EMS).

18. A computer-readable storage medium storing computer-executable instructions which, when executed by a computer, cause the computer to perform a method to verify a media service feature in a communication network, the method comprising:
connecting a communication device to the network;
logging into a test unit communicatively coupled to the network using the communication device;
entering into the communication device an access code corresponding to a test for verifying a media service feature; and
conducting the test for verifying the media service feature, corresponding to the access code.

19. The computer-readable storage medium as set forth in claim 18, wherein said logging includes entering a directory code corresponding to the test unit.

20. The computer-readable storage medium as set forth in claim 18, wherein the test verifies all media service features on a communication path associated with at least one subscriber terminal.
